(19) United States
(12) Patent Application Publication
(10) Pub. No.: US 2025/0360950 A1
(43) Pub. Date: Nov. 27, 2025

(54) RAIL VEHICLE

(71) Applicant: AutoStore Technology AS, Nedre Vats (NO)

(72) Inventors: Trond Austrheim, Etne (NO); Ivar Fjeldheim, Haugesund (NO); Ingvar Fagerland, Kolnes (NO)

(21) Appl. No.: 18/873,439

(22) PCT Filed: Jun. 15, 2023
(86) PCT No.: PCT/EP2023/066129

§ 371 Date: Dec. 10, 2024

(30) Foreign Application Priority Data
Jun. 29, 2022 (NO) 20220738

(51) Int. Cl. B61C 13/04; B61B 5/02; B65G 1/04

(52) U.S. Cl. CPC B61C 13/04; B61B 5/02; B65G 1/0464

(57) ABSTRACT

Rail vehicle (2) for moving in two perpendicular horizontal directions on a rail system (108), the rail system comprising a first set of parallel rails (110) in a first direction (X) and a second set of parallel rails (111) in a second direction (Y) being perpendicular to the first direction (X), the rail vehicle comprising a vehicle frame (3); rail engaging supports (4); and a plurality of wheel modules (5) configured to move the vehicle on the rail system; wherein each wheel module (5) comprises a wheel (6) with a horizontal axis of rotation, the wheel module allowing the wheel to pivot 90 degrees around a vertical axis such that the rotational direction of the wheel may be switched between the first direction (X) and the second direction (Y); the wheel modules (5) and the rail engaging supports (4) are vertically moveable relative to each other between a first position and a second position so to engage and disengage the wheels from the rails.

### FIELD OF THE INVENTION

The present invention relates to a rail vehicle, an automated storage and retrieval system comprising the rail vehicle and a method of changing the travel direction of the rail vehicle.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a horizontal grid-based rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201,301,401 so that the position of the lifting frame 404d with respect to the vehicle 201,301,401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lift device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The prior art container-handling vehicles 201,301,401 described above features a wheel assembly that allows a very fast change of movement between the x- and y-direction upon the rail system. This is highly advantageous in a vehicle undergoing multiple changes in its movement direction to follow a transport route when performing the task of efficiently retrieving and storing a single storage container. However, the prior art wheel assemblies are somewhat complex and require for instance eight wheels and at least two wheel drive motors.

Other types of vehicles operating on a rail system as described above, i.e. rail vehicles, may be configured to perform various tasks in which the speed of changing the movement direction is not an important issue for efficiency.

In view of the above, it is desirable to provide a rail vehicle wherein the wheel assembly is less complex and/or more cost efficient.

### SUMMARY OF THE INVENTION

The present invention is defined in the attached claims and in the following:

In a first aspect, the present invention provides a rail vehicle for moving in two perpendicular horizontal directions on a rail system, the rail system comprising a first set of parallel rails in a first direction and a second set of parallel rails in a second direction being perpendicular to the first direction, the rail vehicle comprising
a vehicle frame;
rail engaging supports for supporting the vehicle on the rail system; and
a plurality of wheel modules configured to move the vehicle on the rail system;
   wherein each wheel module comprises a wheel with a horizontal axis of rotation, the wheel module allowing the wheel to pivot 90 degrees around a vertical axis such that the rotational direction of the wheel may be switched between the first direction and the second direction;
the wheel modules and the rail engaging supports are vertically moveable relative to each other between a first position and a second position, where:
   in the first position, the wheels are arranged to engage rails of the rail system and the rail engaging supports are clear of the rail system (or alternatively, in the first position, a lower level of the wheels is arranged below a lower portion of the rail engaging supports, such that the wheels may engage the rail system while the rail engaging supports are clear of the rail system); and
   in the second position, the rail engaging supports are arranged to engage rails of the rail system and the wheels are lifted clear of the rail system (alternatively; in the second position, the lower portion of the rail engaging supports is below a lower level of the wheels, such that the rail engaging supports may engage the rail system while the wheels are lifted clear of the rail system), such that each of the wheels may be pivoted around the vertical axis of the wheel module to switch the rotational direction of the wheel between the first direction and the second direction.

Each of the rails may comprise at least one wheel track and the rail engaging supports may be configured to support the vehicle via the wheel tracks of the first or second set of rails.

The rail system may also be termed a horizontal rail system.

The wheel modules and the rail engaging supports are vertically moveable relative to each other between a first position and a second position, in that the wheel modules or the rail engaging supports are vertically moveable relative to the rail engaging supports and the wheel modules, respectively, such that the wheel modules and the rail engaging supports may move between a first position and a second position.

In an embodiment of the rail vehicle, the wheel modules may be arranged at a fixed level relative to the vehicle frame while the rail engaging portions are vertically moveable relative to the wheel modules and the vehicle frame, such that the wheel modules and the rail engaging supports are vertically moveable relative to each other between a first position and a second position.

In the second position, the rail engaging supports may be configured to be in contact with the first or second set of parallel rails. The rail engaging support may have a lower portion configured to fit into a wheel track of the first or second set of parallel rails.

In an embodiment of the rail vehicle, the rail engaging supports are configured to hold the vehicle frame at a predetermined level relative to the rail system when in the second position. When the vehicle frame is held at the predetermined level, the wheels of the wheel modules are arranged above the rail system and may be pivoted around the vertical axis to change the rotational direction of the wheels between the first direction and the second direction.

In an embodiment of the rail vehicle, the rail engaging supports may be arranged on opposite sides of the vehicle frame. The rail engaging supports may be arranged on two opposite sides of the vehicle frame.

In an embodiment, the rail vehicle may have four lower corner sections and a wheel module may be arranged at each of the lower corner sections.

In an embodiment of the rail vehicle, each of the rail engaging supports may comprise a lower portion having a width being equal to or less than the width of the wheels.

In an embodiment of the rail vehicle, the rail engaging supports on each of two opposite sides of the vehicle frame may be arranged between two wheel modules, i.e. the rail vehicle may have two wheel modules arranged on each of the two opposite sides. The rail engaging supports may be arranged in a vertical plane containing the wheels of the two wheel modules between which the rail engaging supports are arranged when the rotational direction of the two wheels is in the first direction or the second direction.

In an embodiment of the rail vehicle, the rail engaging supports may be connected to an actuator assembly configured to move the vehicle rail supports and the wheels in a vertical direction relative to each other, the actuator assembly comprising at least one actuator. The actuator may be a rotary actuator or a linear actuator, such as an electric rotary motor or an electric linear actuator.

In an embodiment of the rail vehicle, the rail engaging supports are vertically moveable relative to the vehicle frame and the wheel modules. The wheel modules and the corresponding wheels may be at a fixed level relative to the vehicle frame.

In an embodiment of the rail vehicle, the actuator assembly may be configured to move the rail engaging supports in a vertical direction relative to the vehicle frame. In other words, the actuator assembly may be configured to move the vehicle rail supports such that lower portions of the vehicle rail supports are moved in a vertical direction.

In an embodiment of the rail vehicle, each of the rail engaging supports may be provided by a portion of a lever arm and the actuator assembly is configured to pivot the lever arm between the first position and the second position to displace the portion of the lever arm providing the rail engaging support vertically with respect to the vehicle frame.

In an embodiment of the rail vehicle, the actuator assembly may comprise a linkage arrangement on each of two opposite sides of the vehicle frame, each linkage arrangement coupled to at least one of the rail engaging supports, wherein the linkage arrangements are interconnected by a horizontal shaft and configured such that the rail engaging supports will move between the first position and the second position when the shaft rotates.

In an embodiment, the rail vehicle may comprise a wheel pivoting assembly configured to pivot the wheels simultaneously around the corresponding vertical axes, such that the rotational direction of the wheels may turn 90 degrees, i.e. such that the rotational direction of the wheels may switch between the first direction and the second direction. The term “rotational direction” is intended to mean the direction in which the wheel may travel when rotating.

In an embodiment of the rail vehicle, the wheel pivoting assembly may comprise a plurality of vertical shafts, each shaft connected to a corresponding wheel module, the shafts being rotatable by a wheel pivoting actuator to pivot the wheels around the corresponding vertical axes.

In an embodiment of the rail vehicle, the wheel pivoting assembly may comprise links interconnecting the plurality of vertical shafts and the wheel pivoting actuator, the links configured to convert movement of the wheel pivoting actuator into rotational movement of the vertical shafts. Each of the shafts may comprise a lever element configured to convert linear movement from the links into rotational movement of the shafts.

The links and the lever elements may be configured such that two of the shafts rotate in the opposite direction of the remaining two shafts.

In an embodiment of the rail vehicle, at least one of the wheel modules may comprise an electric motor for driving the respective wheel of the wheel module.

In an embodiment of the rail vehicle, at least one of the wheel modules may comprise a sensor for detecting the position of the wheel, and thus the rail vehicle, relative to the rail system.

In an embodiment of the rail vehicle, each wheel module may comprise a single wheel.

In a second embodiment, the present invention provides a container handling system comprising a rail vehicle and a rail system, the rail system comprising a first set of parallel rails in a first direction and a second set of parallel rails in a second direction being perpendicular to the first direction, the rail vehicle comprising:
a vehicle frame;
rail engaging supports for supporting the vehicle on the rail system; and
a plurality of wheel modules configured to move the vehicle upon the rail system;
wherein each wheel module comprises a wheel with a horizontal axis of rotation, the wheel module allowing the wheel to pivot 90 degrees around a vertical axis such that the rotational direction of the wheel may be switched between the first direction and the second direction;
the wheel modules and the rail engaging supports are vertically moveable relative to each other between a first position and a second position, where:
   in the first position, the wheels engage rails of the rail system and the rail engaging supports are arranged above the rail system; and
   in the second position, the rail engaging supports engage rails of the rail system and the wheels are arranged above the rail system, such that each of the wheels may be pivoted around the vertical axis of the wheel module to switch the rotational direction of the wheel between the first direction and the second direction.

The term “container handling system” is intended to encompass handling systems comprising any type of containers, bins or frames that may accommodate any type of item, goods or merchandise, including growth media in which plants may be cultivated. In the latter case, the container handling system may be used for vertical farming.

In an embodiment of the container handling system, each rail of the first set of parallel rails and the second set of parallel rails may comprise at least one wheel track for guiding the wheels when in the first position, and each of the rail engaging supports comprises a lower portion configured to fit inside one of the wheel tracks when the rail engaging supports are in the second position. A width of the lower portion of the rail engaging supports may be equal or less than a width of the wheel tracks. When the rail engaging supports are in the second position, the rail vehicle may be supported on upwards facing surfaces of the wheel tracks via the lower portions of the rail engaging supports.

In an embodiment, the container handling system may comprise vertical column profiles supporting the rail system from below, the column profiles defining multiple storage columns in which containers may be stacked on top of each other.

In further embodiments of the container handling system, the rail vehicle may be a rail vehicle according to any embodiment of the first aspect of the invention.

In an embodiment of the container handling system, each storage column is defined by four of vertical column profiles.

In an embodiment of the container handling system, the first and second set of rails may provide a horizontal grid-based rail system defining a plurality of grid cells.

In an embodiment of the container handling system, the footprint of the rail vehicle may be about the size of 2×2 grid cells of the rail system. A grid cell may be defined as the cross-sectional area between the vertical centre planes of opposed rails running in the first direction and opposed rails running in the second direction.

A grid cell opening may be defined as the open cross-sectional area between two opposed rails running in the first direction and two opposed rails running in the second direction.

In a third aspect, the present invention provides a method of changing the direction of travel of a rail vehicle operating on a rail system, the rail system comprising a first set of parallel rails in a first direction and a second set of parallel rails in a second direction being perpendicular to the first direction, the rail vehicle comprising
a vehicle frame;
rail engaging supports for supporting the vehicle on the rail system; and
a plurality of wheel modules configured to move the vehicle upon the rail system;
wherein each wheel module comprises a wheel with a horizontal axis of rotation, the wheel module allowing the wheel to pivot 90 degrees around a vertical axis such that the wheel may change its rotational direction between the first direction and the second direction;
the wheel modules and the rail engaging supports are vertically moveable relative to each other between a first position and a second position, where:
   in the first position, the wheels are arranged to engage rails of the rail system and the rail engaging supports are clear of the rail system; and
   in the second position, the rail engaging supports are arranged to engage rails of the rail system and the wheels are lifted clear of the rail system, such that the wheels may pivot around the vertical axis to change the rotational direction between the first direction and the second direction, the method comprising the steps of:
      moving the rail vehicle in the first direction on the rail system;
      stopping the rail vehicle;
      moving the wheel modules and the rail engaging supports relative to each other from the first position to the second position;
      pivoting the wheels 90 degrees around the vertical axis such that the wheels switch their rotational direction from the first direction to the second direction;
      moving the wheel modules and the rail engaging supports from the second position to the first position; and
      moving the rail vehicle in the second direction upon the rail system.

In an embodiment of the method, the container handling system may be according to any of the embodiments of the second aspect of the invention.

In a fourth aspect, the present invention provides a rail vehicle for moving in two perpendicular horizontal directions on a rail system, where the rail system comprises a first set of parallel rails in a first direction and a second set of parallel rails in a second direction being perpendicular to the first direction, the vehicle comprises wheels for engaging the rails, the wheels having a horizontal rolling axis and being arranged to guide the vehicle along the rails in either the first direction or the second direction, the wheels being arranged to pivot 90 degrees about a vertical axis to change the wheels over from rolling on one set of rails to the other set of rails in order to change direction of movement of the vehicle, and the vehicle being provided with rail engaging supports that are arranged to be lowered into engagement with the rails in order to lift the wheels clear of the rails when the wheels are being pivoted about the vertical axis.

In an embodiment of the fourth aspect, the rail vehicle may be a storage container handling vehicle.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIGS. 5 and 6 are perspective side views of a first exemplary rail vehicle according to the invention.

FIG. 7 is a perspective view of an upper section of the rail vehicle in FIGS. 5 and 6.

FIG. 8 is a perspective view of a lower section of the rail vehicle in FIGS. 5 and 6.

FIGS. 9-12 are perspective views of the lower section of the rail vehicle in FIGS. 5 and 6, illustrating the steps performed when the rail vehicle changes the direction of travel.

FIG. 13 is an exploded view of an exemplary wheel module of the rail vehicle in FIGS. 5 and 6.

FIG. 14 is a perspective side view of the rail vehicle in FIGS. 5 and 6, illustrating its use as a container handling vehicle.

FIG. 15 is a perspective side view of a second exemplary rail vehicle according to the invention.

FIG. 16 is a perspective side view of a third exemplary rail vehicle according to the invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

As mentioned above, the wheel assemblies of the prior art container-handling vehicles 201,301,401 are somewhat complex and require for instance eight wheels and at least two wheel drive motors to allow movement in both the first direction X and the second direction Y on the rail system 108.

The present invention provides an alternative type of rail vehicle. The rail vehicle is for operating on a rail system 108 and may be configured to perform various tasks in which the speed of changing the movement direction is not an important issue for efficiency. Such rail vehicles may e.g. be configured to retrieve multiple storage containers from the same storage column 105, configured to retrieve/store growth frames in a vertical farming system and/or configured to transport a human operator.

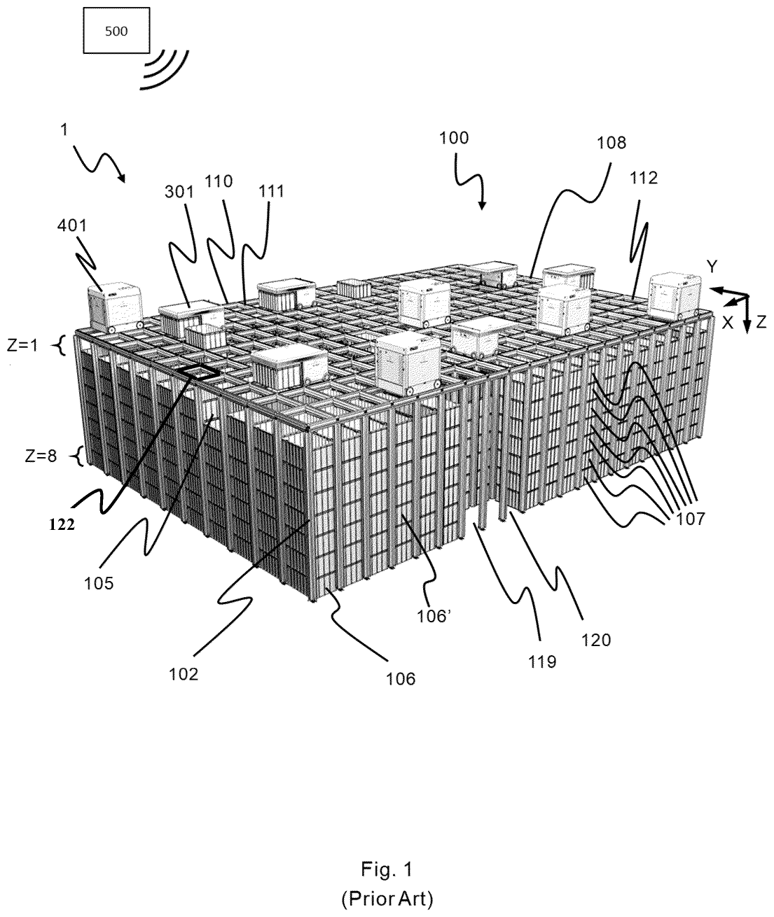

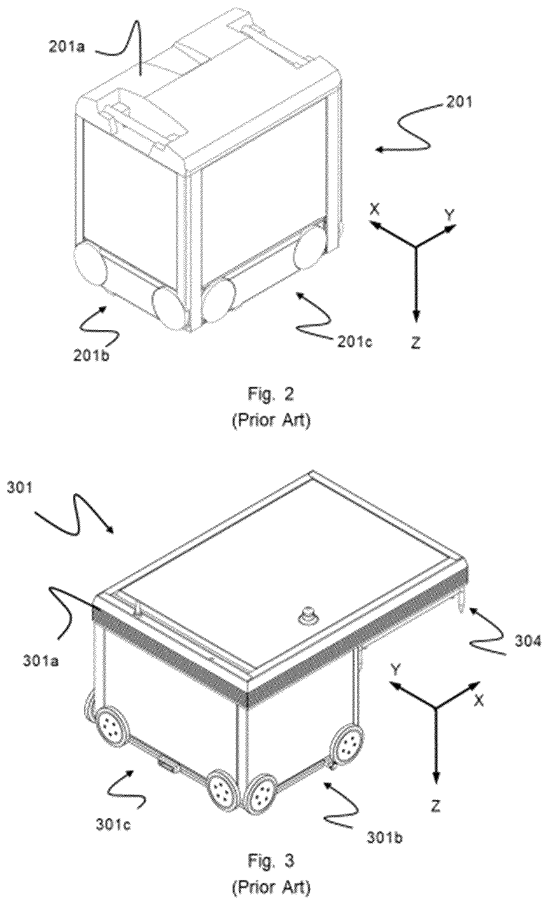

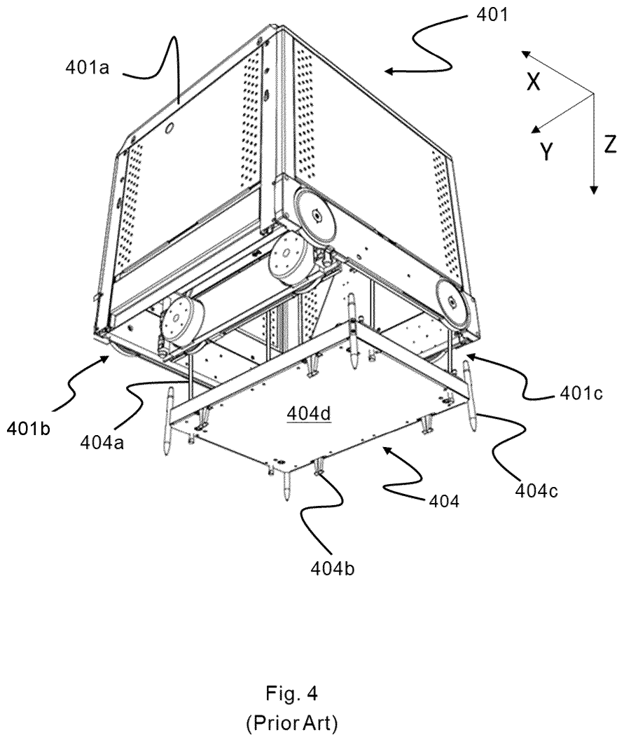

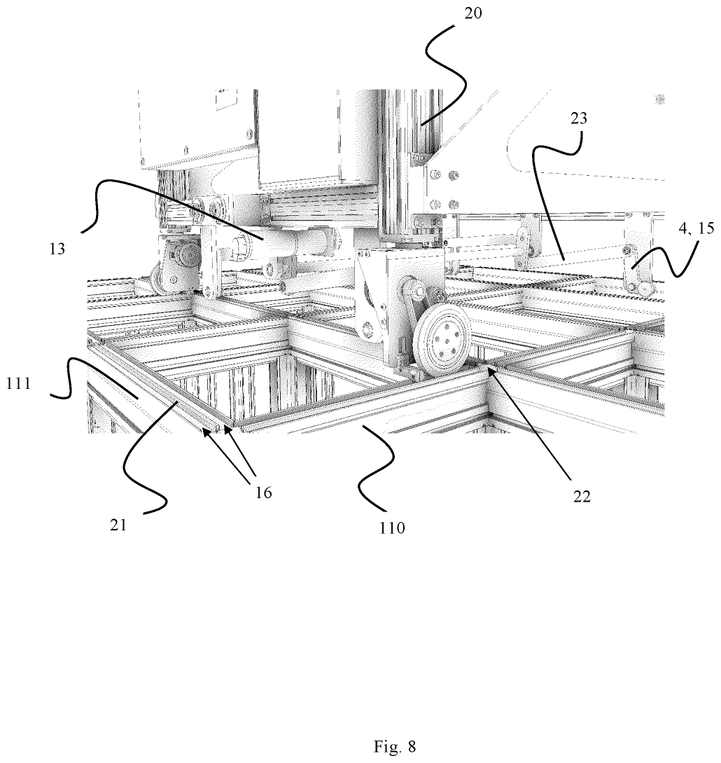

The rail vehicle according to the invention is intended for use in automated storage and retrieval systems, also termed a container handling system, having a framework structure 100 as described above in connection with FIGS. 1-3. The framework structure 100 comprises a plurality of upright members 102 (i.e. vertical column profiles) and a rail system 108 forming a rail grid extending in the first direction X and the second direction Y. The rail system 108 features a first set of parallel rails 110 in the first direction and a second set of parallel rails 111 in the second direction. Each rail has at least one wheel track 16, see FIG. 8. The upright members 102 define storage columns 105 in which containers 106 may be stacked on top of each other. The containers of the automated storage and retrieval system may be configured to fulfil various functions, such as storage of items and goods and growth modules for plants. In the latter case, the automated storage and retrieval system may also be termed a vertical farming system.

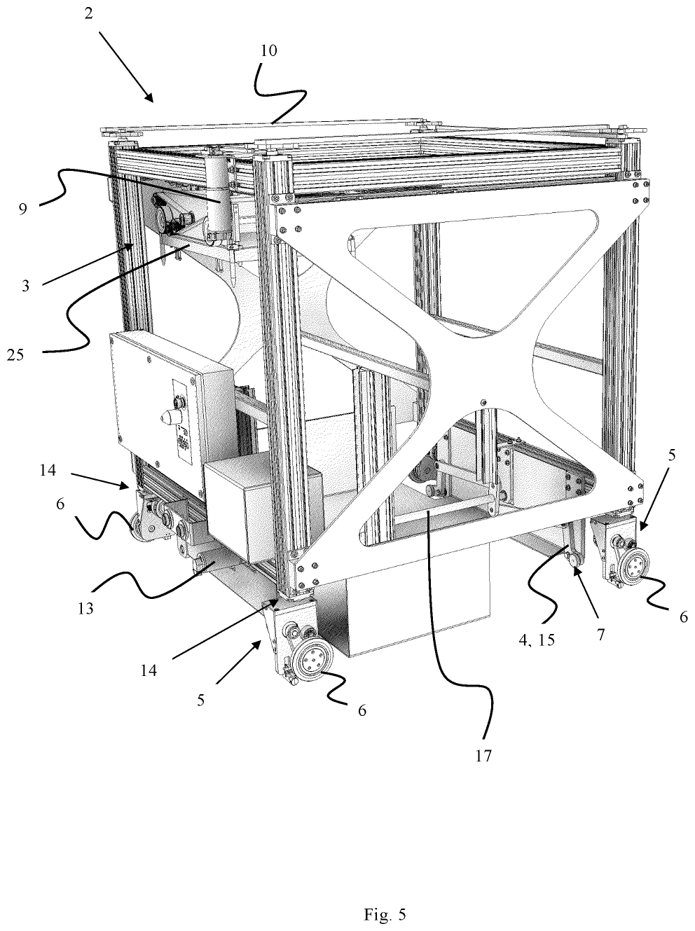

A first exemplary embodiment of a rail vehicle 2 according to the invention is shown in FIGS. 5-14.

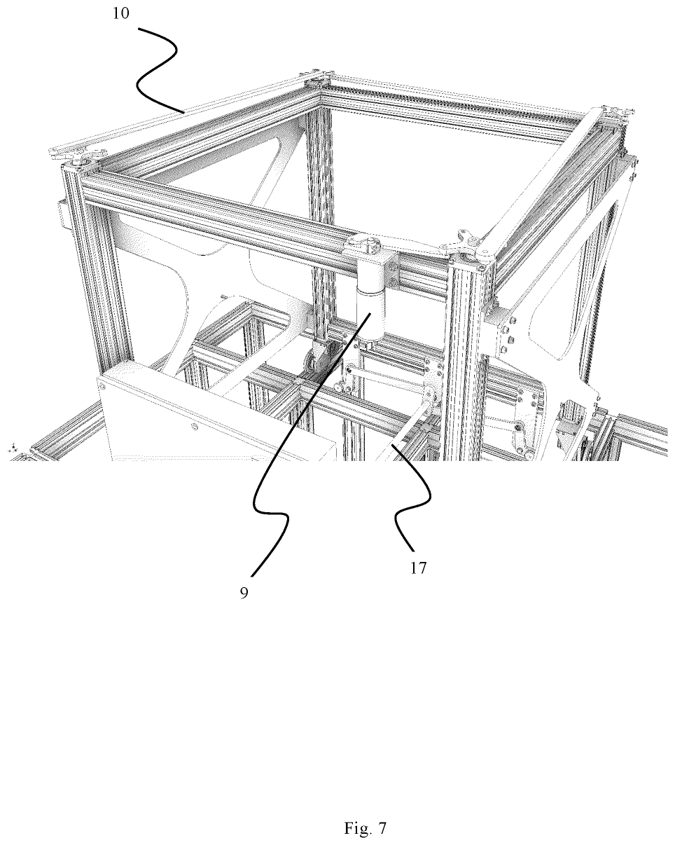

The rail vehicle 2 has a vehicle frame 3, rail engaging supports 4 for supporting the vehicle on the rail system 108 (see FIGS. 7-12) and four wheel modules 5 configured to move the vehicle on the rail system 108. The rail engaging supports 4 are arranged on two opposite sides of the vehicle frame 3.

The wheel modules 5 are arranged at lower corner sections 14 of the vehicle frame 3. Each wheel module 5 comprises a wheel 6 with a horizontal axis of rotation, and the wheel 6 is allowed to pivot 90 degrees around a vertical axis such that the wheel may switch its rotational direction between the first direction X and the second direction Y upon the rail system 108.

An exploded view of a wheel module 5 is shown in FIG. 13. The illustrated wheel module 5 features an electric wheel motor 11, a wheel 6 and a sensor 12. The wheel motor is coupled to the wheel 6 via a drive band 18 and an assembly of drive wheels 19. In alternative embodiments, the wheel motor 11 may be directly connected to the wheel and/or be an integrated wheel hub motor. The sensor 12 is configured to detect the position of the wheel module 5 relative to the rail system 108. Each of the wheel modules 5 is pivotably connected at a lower end of a vertical profile 20 of the vehicle frame 3.

In the illustrated rail vehicle 2, each of the four wheel modules 5 is provided with a wheel motor 11 and a sensor 12. However, in alternative embodiments it is sufficient that at least one of the wheel modules 5 has a wheel motor 11 provided the required movement of the rail vehicle 2 is obtained. Similarly, depending on the configuration of the sensor, only one of the wheel modules may be required to feature a sensor 12.

During movement of the rail vehicle 2 upon the rail system, the wheels are guided by the wheel tracks 16 of the first or second set of rails 110,111. The wheel tracks 16 are defined by flanges 21 extending between the rail intersections 22 of the rail system 108. To obtain optimum guidance of the wheels 6, the flanges 21 extend as far as possible without compromising the movement of the wheels through the rail intersections 22. To pivot the wheel modules 5 while the wheels 6 are in contact with the rail system 108, the diameter of the wheels must either be very small, or the flanges would have to be shorter. None of these solutions are optimal. For instance, smaller wheels provide less traction and lower tolerances towards minor irregularities of the rail system 108, while shorter flanges 21 will not provide sufficient guidance of the wheels 6.

Thus, to allow the wheel modules 5 to pivot, to switch the direction of travel of the rail vehicle 2, the rail engaging supports 4 are vertically moveable relative to the wheel modules 5 between a first position and a second position. It is noted that in the illustrated embodiment the rail engaging supports 4 are vertically moveable relative to the vehicle frame 3 and the wheel modules 5. However, in alternative embodiments, an opposite configuration may be used, i.e. by having the wheel modules 5 vertically moveable relative to the vehicle frame 3 and the rail engaging supports 4 fixed.

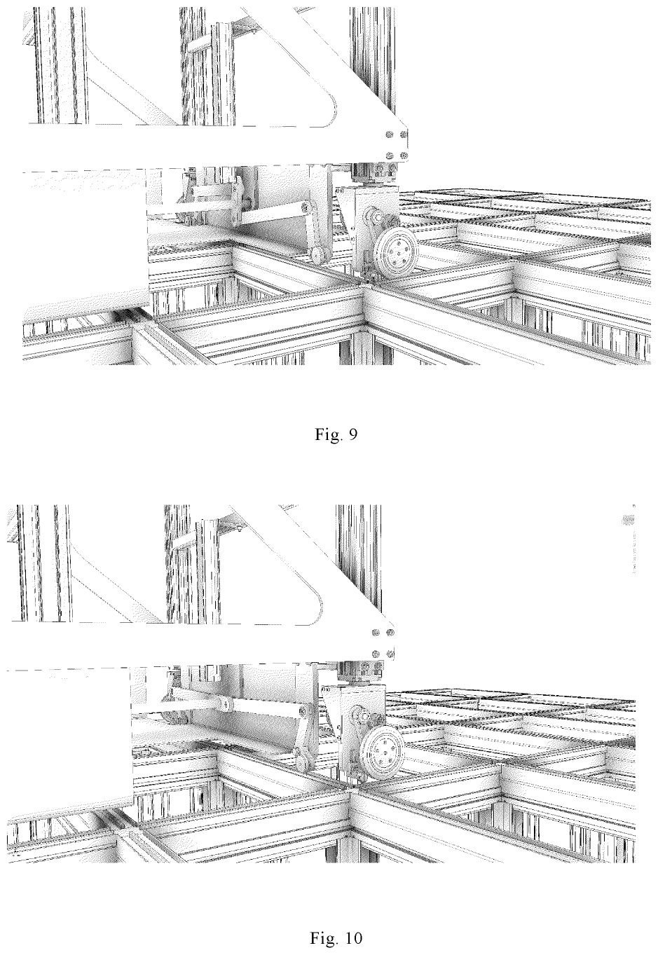

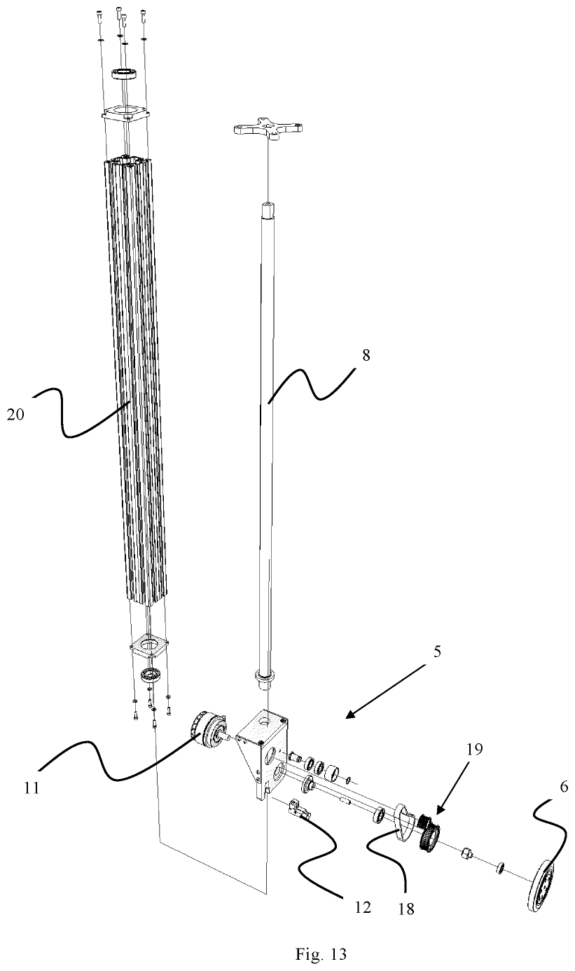

In the first position, see FIGS. 9 and 12, the wheels 6 are arranged to engage the rail system 108 and the rail engaging supports 4 are clear of the rail system, i.e. above the flanges 21 of the rail system. In other words, a lower level of the wheels 6 is arranged below a lower portion 7 of the rail engaging supports 4, such that the wheels 6 may engage rail of the rail system 108 while the rail engaging supports 4 are clear of the rail system 108.

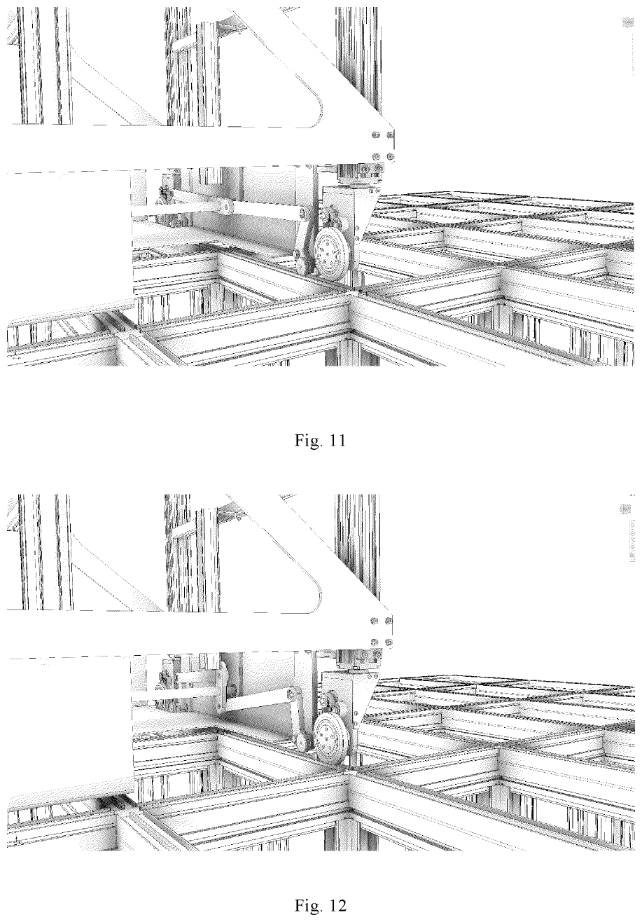

In the second position, see FIGS. 10 and 11, the rail engaging supports 4 are arranged to engage rails of the rail system and the wheels 6 are lifted clear of the rail system 108, such that the wheels 6 may pivot around the vertical axis to change the rotational direction between the first direction X and the second direction Y. In other words, the lower portion 7 of the rail engaging supports 4 is below a lower level of the wheels 6, such that the rail engaging supports 4 may engage rails of the rail system while the wheels 6 are lifted clear of the rail system to allow the wheels to pivot around the vertical axis without interacting with the rail system. The wheels 6 are pivoted by operating a wheel pivoting assembly as discussed below.

In the second position, the rail engaging supports 4 are configured to hold the vehicle frame 3 at a fixed level relative to the rail system 108. Each of the rail engaging supports 4 has a lower portion 7 that fits within the wheel track 16 when the rail engaging supports 4 are in the second position. In other words, the lower portion has a width being equal to or less than the width of the wheel track 16. The rail engaging supports 4 may be seen as a set of feet which are lowered with respect to the vehicle frame to lift the remainder of the rail vehicle 2 and its wheel modules 5 up off the rails of the rail system 108.

Having the vehicle supported by in this manner provides optimum stability of the vehicle in the second position and further avoids potential damage to the flanges 21 of the rails 110,111. In the illustrated embodiment, the rail engaging supports 4 comprise lever arms 15 which are moved into the second position in an arcuate movement. To reduce friction between the lower portions 7 of the rail engaging supports 4 and the rails during this movement, the lower portion is in the form of a small wheel. The lower portion may in other embodiments have any shape or configuration allowing the lower portion 7 to slide or move along the rails during the final arcuate movement towards the second position. It is noted that in further embodiments, e.g. wherein the rail engaging supports 4 are moved into the second position in a linear vertical direction, the lower portions 7 are not required to slide along the rails.

The rail engaging supports 4 are connected to an actuator assembly configured to move the rail engaging supports 4 in a vertical direction relative to the vehicle frame 3 and the wheel modules 5. The actuator assembly comprise an electric motor 13 (i.e. an actuator), a linkage arrangement 23 on each of two opposite sides of the vehicle frame 3 and a shaft 17 interconnecting the two linkage arrangements 23. Each of the linkage arrangements is coupled to two lever arms 15 and configured such that the lever arms 15 will pivot between the first position and the second position when the shaft 17 is rotated by operating the motor 13. In alternative embodiments, the actuator assembly may have any configuration suitable for moving the rail engaging supports 4 in a vertical direction between the first and second position, e.g. by use of at least one electric linear actuator.

To switch the rotational direction of the wheels 6 by 90 degrees when the wheel modules 5 are in the second position, the rail vehicle 2 features a wheel pivoting assembly configured to pivot the wheels 6 simultaneously around the corresponding vertical axes. The wheel pivoting assembly comprises four vertical shafts 8, each shaft connected to a corresponding wheel module 5. The shafts 8 extend from the wheel modules, through the vertical profiles 20 to an upper level of the vehicle frame 3. Upper ends of the vertical profiles 20 are coupled to an electric motor 9 (i.e. a wheel pivoting actuator) via a set of links 10 and levers 24. The links 10, the levers 24 and the electric motor 9 are configured to rotate the shafts 8 such that the wheels will pivot simultaneously around the corresponding vertical axes when the electric motor 9 is operated. In the illustrated embodiment, the centerline of the shafts 8 are colinear with the vertical axes. In other embodiments the centerlines of the shafts 8 may be parallel to the vertical axes, e.g. by transferring the rotational movement of the shafts to the wheel modules by cog wheels and/or drive bands.

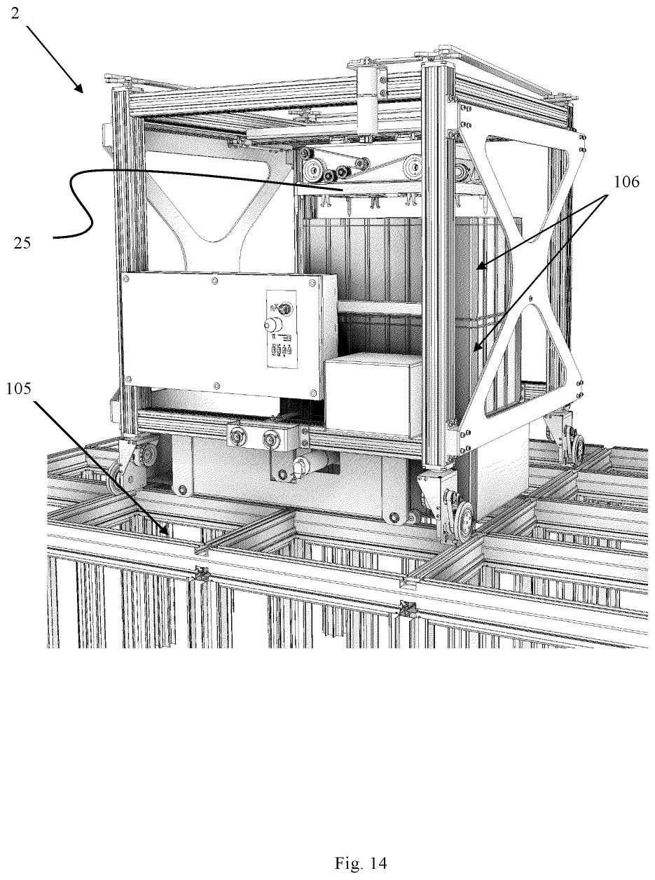

The first exemplary rail vehicle 2 is a container handling vehicle comprising a lifting device suitable for retrieving or storing storage containers 106, see FIG. 14, from/to the storage columns 105 of an automated storage and retrieval system as described above.

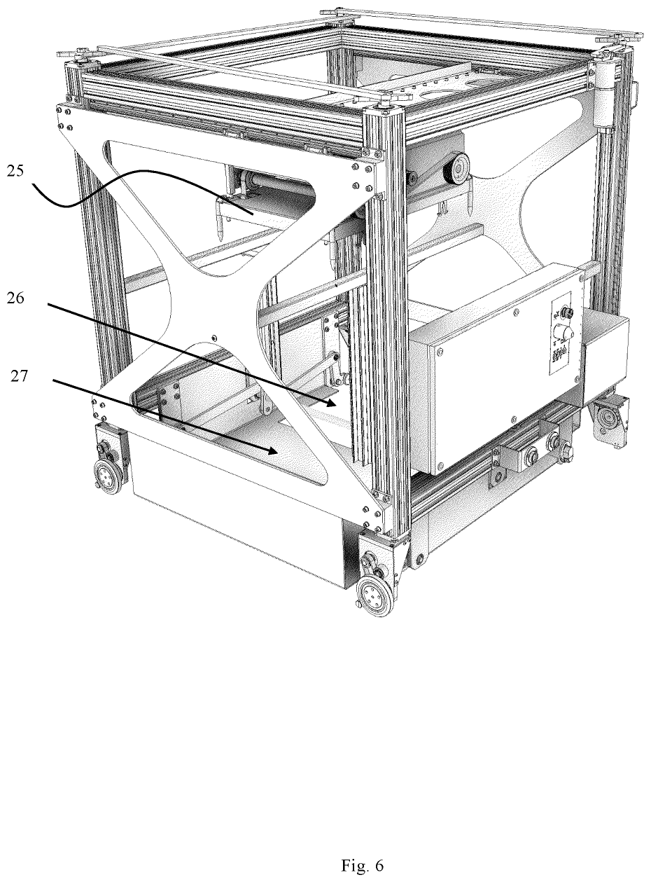

The lifting device features a lifting frame 25 similar to the lifting frame 404d of the prior art container handling vehicles described above. The lifting frame 25 is configured to be horizontally moveable between a position above an access opening 26 and a position above a storage section 27 within the rail vehicle, see FIG. 6. When arranged above the access opening 26, the lifting frame may be lowered into a storage column 105. In this manner, the lifting device may be used to both store storage containers 106 in the storage section 27 within the rail vehicle 2 and retrieve or store storage containers 106 from/to the storage columns 105.

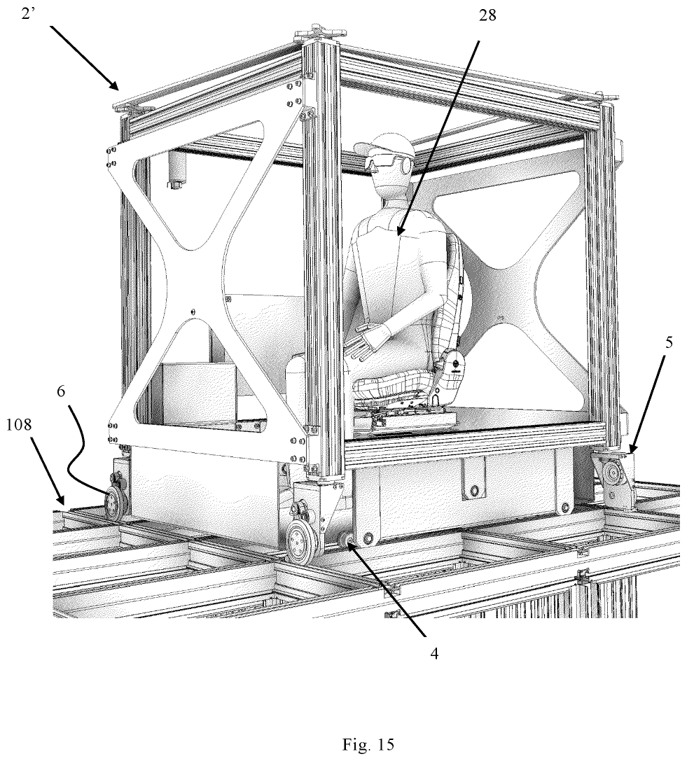

A second exemplary embodiment of a rail vehicle 2′ according to the invention is shown in FIG. 15.

The rail vehicle 2′ has most of the features in common with the rail vehicle 2 described above, but instead of being configured to handle storage containers, it is configured to transport a human operator 28 upon the rail system 108.

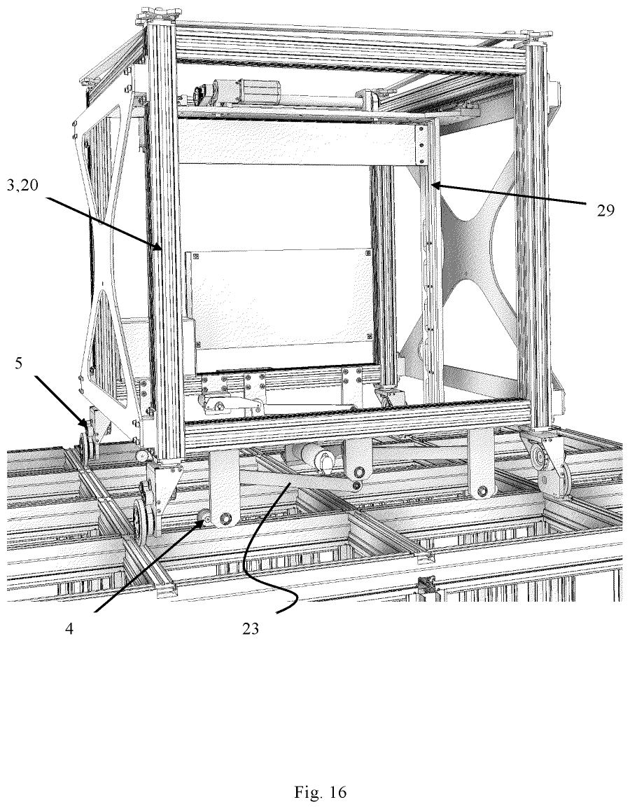

A third exemplary embodiment of a rail vehicle 2″ according to the invention is shown in FIG. 16.

The rail vehicle 2″ has most of the features in common with the rail vehicle 2 described above, but instead of being configured to handle storage containers, it is configured with a lifting device 29 for containers shaped as vertical frames having a growth medium for growing plants. The rail vehicle 2″ is for use in an automated storage and retrieval system as described above configured for vertical farming.

### List of Reference Numbers

1 Prior art automated storage and retrieval system
2 Rail vehicle
3 Vehicle frame
4 Rail engaging support
5 Wheel module
6 Wheel
7 Lower portion (of rail engaging support)
8 Vertical shaft
9 Wheel pivoting actuator, electric motor
10 Link
11 Motor, wheel motor
12 Sensor
13 Electric motor, actuator
14 Corner section
15 Lever arm
16 Wheel track
17 Horizontal shaft
18 Drive band
19 Drive wheel
20 Vertical profile
21 Flange
22 Rail intersection
23 Linkage arrangement
24 Lever
25 Lifting frame
26 Access opening
27 Storage section
28 Human operator
29 Lifting device
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1-20. (canceled)

21. A rail vehicle for moving in two perpendicular horizontal directions on a rail system, the rail system comprising a first set of parallel rails in a first direction and a second set of parallel rails in a second direction being perpendicular to the first direction, the rail vehicle comprising:
a vehicle frame;
rail engaging supports for supporting the rail vehicle on the rail system; and
a plurality of wheel modules configured to move the rail vehicle on the rail system; wherein each wheel module comprises a wheel with a horizontal axis of rotation, each of the plurality of wheel modules allowing the wheel to pivot 90 degrees around a vertical axis such that a rotational direction of the wheel may be switched between the first direction and the second direction;
each of the plurality of wheel modules and the rail engaging supports are vertically moveable relative to each other between a first position and a second position, where:
in the first position, the wheels are arranged to engage rails of the rail system and the rail engaging supports are clear of the rail system; and
in the second position, the rail engaging supports are arranged to engage rails of the rail system and the wheels are lifted clear of the rail system, such that each of the wheels may be pivoted around the vertical axis of each of the plurality of wheel modules to switch the rotational direction of the wheel between the first direction and the second direction.

22. A rail vehicle according to claim 21, wherein the rail engaging supports are configured to hold the vehicle frame at a predetermined level relative to the rail system when in the second position.

23. A rail vehicle according to claim 21, wherein the rail engaging supports are arranged on opposite sides of the vehicle frame.

24. A rail vehicle according to claim 21, having four lower corner sections and a wheel module is arranged at each of the four lower corner sections.

25. A rail vehicle according to claim 21, wherein each of the rail engaging supports comprises a lower portion having a width being equal to or less than the width of the wheels.

26. A rail vehicle according to claim 21, wherein the rail engaging supports are connected to an actuator assembly configured to move the rail engaging supports and the wheels in a vertical direction relative to each other, the actuator assembly comprising at least one actuator.

27. A rail vehicle according to claim 26, wherein the rail engaging supports are vertically moveable relative to the vehicle frame and the plurality of wheel modules.

28. A rail vehicle according to claim 27, wherein the actuator assembly is configured to move the rail engaging supports in a vertical direction relative to the vehicle frame.

29. A rail vehicle according to claim 28, wherein each of the rail engaging supports is provided by a portion of a lever arm and the actuator assembly is configured to pivot the lever arm between the first position and the second position to displace the portion of the lever arm providing the rail engaging support vertically with respect to the vehicle frame.

30. A rail vehicle according to claim 28, wherein the actuator assembly comprises a linkage arrangement on each of two opposite sides of the vehicle frame, each linkage arrangement coupled to at least one of the rail engaging supports, wherein the linkage arrangements are interconnected by a horizontal shaft and configured such that the rail engaging supports will move between the first position and the second position when the horizontal shaft rotates.

31. A rail vehicle according to claim 21, comprising a wheel pivoting assembly configured to pivot the wheels simultaneously around corresponding vertical axes.

32. A rail vehicle according to claim 31, wherein the wheel pivoting assembly comprises a plurality of vertical shafts, each vertical shaft connected to a corresponding wheel module, each of the plurality of vertical shafts being rotatable by a corresponding wheel pivoting actuator to pivot the wheels around the corresponding vertical axes.

33. A rail vehicle according to claim 32, wherein the wheel pivoting assembly comprises links interconnecting each of the plurality of vertical shafts and the corresponding wheel pivoting actuator, the links configured to convert movement of the corresponding wheel pivoting actuator into rotational movement of each the plurality of vertical shafts.

34. A rail vehicle according to claim 21, wherein at least one of the plurality of wheel modules comprises a motor for driving a respective wheel of the at least one of the wheel modules.

35. A rail vehicle according to claim 21, wherein at least one of the plurality of wheel modules comprises a sensor for detecting a position of the wheel relative to the rail system.

36. A rail vehicle according to claim 21, wherein each wheel module comprises a single wheel.

37. A container handling system comprising a rail vehicle and a rail system, the rail system comprising a first set of parallel rails in a first direction and a second set of parallel rails in a second direction being perpendicular to the first direction, the rail vehicle comprising:
a vehicle frame;
rail engaging supports for supporting the rail vehicle on the rail system; and
a plurality of wheel modules configured to move the rail vehicle upon the rail system;
wherein each wheel module comprises a wheel with a horizontal axis of rotation, each of the plurality of wheel modules allowing the wheel to pivot 90 degrees around a vertical axis such that a rotational direction of the wheel may be switched between the first direction and the second direction;
each of the plurality of wheel modules and the rail engaging supports are vertically moveable relative to each other between a first position and a second position, where:
in the first position, the wheels engage rails of the rail system and the rail engaging supports are arranged above the rail system; and
in the second position, the rail engaging supports engage rails of the rail system and the wheels are arranged above the rail system, such that each of the wheels may be pivoted around the vertical axis of each of the wheel modules to switch the rotational direction of the wheel between the first direction and the second direction.

38. A container handling system according to claim 37, wherein each rail of the first set of parallel rails and the second set of parallel rails comprises at least one wheel track for guiding the wheels when in the first position, and each of the rail engaging supports comprises a lower portion configured to fit inside one of the at least one wheel tracks when the rail engaging supports are in the second position.

39. A container handling system according to claim 37, comprising vertical column profiles supporting the rail system from below, the vertical column profiles defining multiple storage columns in which containers may be stacked on top of each other.

40. A method of changing a direction of travel of a rail vehicle operating on a rail system, the rail system comprising a first set of parallel rails in a first direction and a second set of parallel rails in a second direction being perpendicular to the first direction, the rail vehicle comprising:
a vehicle frame;
rail engaging supports for supporting the rail vehicle on the rail system; and
a plurality of wheel modules configured to move the rail vehicle upon the rail system;
wherein each wheel module comprises a wheel with a horizontal axis of rotation, each of the plurality of wheel modules allowing the wheel to pivot 90 degrees around a vertical axis such that the wheel may change its rotational direction between the first direction and the second direction;
each of the plurality of wheel modules and the rail engaging supports are vertically moveable relative to each other between a first position and a second position, where:
in the first position, the wheels are arranged to engage rails of the rail system and the rail engaging supports are clear of the rail system; and
in the second position, the rail engaging supports are arranged to engage rails of the rail system and the wheels are lifted clear of the rail system, such that each of the wheels may pivot around the vertical axis of each of the plurality of wheel modules to change a
rotational direction between the first direction and the second direction; the method comprising the steps of:
moving the rail vehicle in the first direction on the rail system;
stopping the rail vehicle;
moving the wheel modules and the rail engaging supports relative to each other from the first position to the second position;
pivoting the wheels 90 degrees around the vertical axis such that the wheels switch their rotational direction from the first direction to the second direction;
moving the plurality of wheel modules and the rail engaging supports from the second position to the first position; and
moving the rail vehicle in the second direction upon the rail system.
